(19) United States
(12) Patent Application Publication
(10) Pub. No.: US 2026/0064940 A1
(43) Pub. Date: Mar. 5, 2026

(54) DYNAMIC PDF ENGINE

(71) Applicant: Truist Bank, Charlotte, NC (US)

(72) Inventors: Taylor Aycock, Charlotte, NC (US); Logendran Kannuthurai, Charlottte, NC (US); Donald Byrd, Charlotte, NC (US)

(73) Assignee: Truist Bank, Charlotte, NC (US)

(21) Appl. No.: 18/822,143

(22) Filed: Aug. 31, 2024

(51) Int. Cl. G06F 40/154; G06F 40/103; G06F 40/177

(52) U.S. Cl. CPC G06F 40/154; G06F 40/103; G06F 40/177

(57) ABSTRACT

Systems, apparatuses, and computer-implemented methods provide for technology that generates a modified XML file based on first input data and a base XML file, wherein the modified XML file includes a first set of reusable objects, and generates a PDF file based on the modified XML file, wherein one or more attributes associated with a first page layout of the PDF file are variable in accordance with the first set of reusable objects.

### TECHNICAL FIELD

Embodiments generally relate to the creation of portable document format (PDF) files. More particularly, embodiments relate to a dynamic PDF engine that automatically handles page breaks and page layout changes during the creation of PDF files.

### BACKGROUND

The generation of portable document format (PDF) files may typically involve the use of low-level libraries and static templates that require fine-grained control of every aspect of the PDF and produce suboptimal results. For example, if the underlying dataset includes a table that spans multiple pages, a conventional PDF creation library might place the column headers only on the first page of the table. Moreover, if the dataset changes over time, conventional solutions may retain the original page layout, which may be unsuitable for the new dataset.

### SUMMARY

In one embodiment, a performance-enhanced computing system comprises a network controller, a processor coupled to the network controller, and a memory coupled to the processor, the memory including a plurality of instructions, which when executed by the processor, cause the processor to generate a modified extensible markup language (XML) file based on first input data and a base XML file, wherein the modified XML file includes a first set of reusable objects, and generate a portable document format (PDF) file based on the modified XML file, wherein one or more attributes associated with a first page layout of the PDF file are variable in accordance with the first set of reusable objects.

In another embodiment, at least one computer readable storage medium comprising a plurality of instructions, which when executed by a computing system, cause the computing system to generate a modified extensible markup language (XML) file based on first input data and a base XML file, wherein the modified XML file includes a first set of reusable objects, and generate a portable document format (PDF) file based on the modified XML file, wherein one or more attributes associated with a first page layout of the PDF file are variable in accordance with the first set of reusable objects.

In another embodiment, a method of operating a performance-enhanced computing system comprises generating, by a request engine, a modified extensible markup language (XML) file based on first input data and a base XML file, wherein the modified XML file includes a first set of reusable components, and generating, by a portable document format (PDF) print engine, a PDF file based on the modified XML file, wherein one or more attributes associated with a first page layout of the PDF file are variable in accordance with the first set of reusable objects.

### DRAWINGS

The various advantages of the exemplary embodiments will become apparent to one skilled in the art by reading the following specification and appended claims, and by referencing the following drawings, in which:

FIG. 1 illustrates a communication environment in accordance with one or more embodiments set forth and described herein;

FIG. 2 illustrates a block diagram of the mobile device of FIG. 1;

FIG. 3 illustrates a block diagram of the personal computing device of FIG. 1;

FIG. 4 illustrates a block diagram of the one or more financial institution servers of FIG. 1;

FIG. 5 is a comparative illustration of an example of a conventional page layout for a portable document format (PDF) file and an enhanced page layout or a PDF file according to an embodiment;

FIG. 6 is a block diagram of an example of a request engine and a PDF print engine according to an embodiment;

FIG. 7 is a flowchart of an example of a method of operating a performance-enhanced computing system according to an embodiment;

FIG. 8 is a block diagram of an example of a performance-enhanced server according to an embodiment; and

FIG. 9 is an illustration of an example of a semiconductor apparatus according to an embodiment.

### DETAILED DESCRIPTION

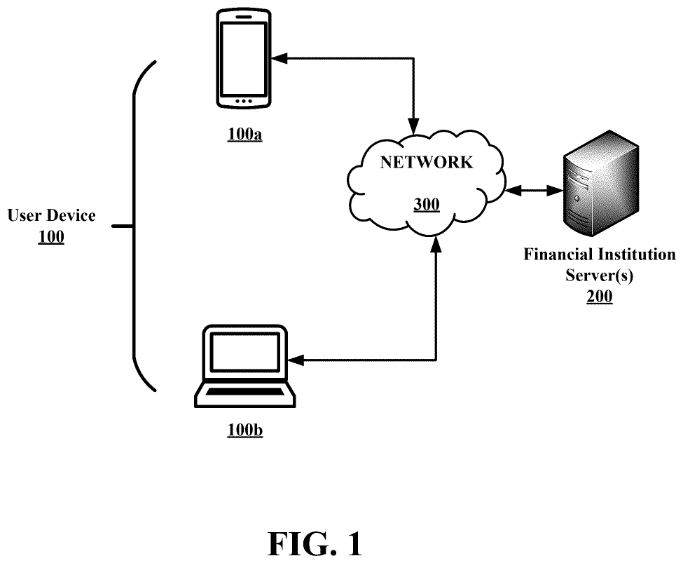

Turning to the figures, in which FIG. 1 illustrates a communication environment in which a user communicates with a financial institution. A user device 100 (100a, 100b) operating in the communication environment facilitates user access to and user management of one or more user accounts residing at one or more financial institution servers 200 of the financial institution. The communication environment includes the user device 100, the one or more financial institution servers 200, and a communications network 300 through which communication is facilitated between the user device 100 and the one or more financial institution servers 200.

In accordance with one or more embodiments, the user device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the user device 100 comprising any form of electronic device that optimizes the performance and functionality of the one or more embodiments in a manner that falls within the spirit and scope of the principles of this disclosure.

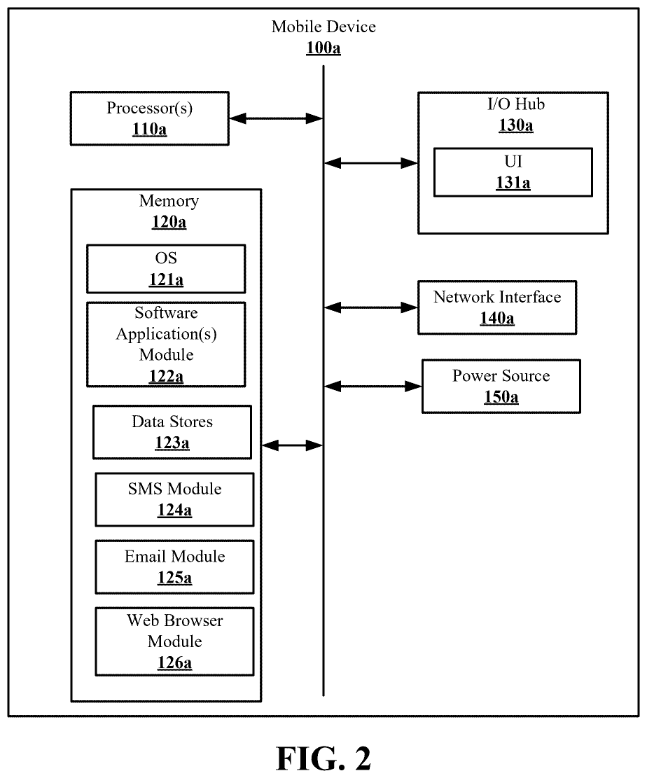

In the illustrated example embodiment of FIG. 2, the user device 100 (FIG. 1) comprises a mobile device 100a. Some of the possible operational elements of the mobile device 100a are illustrated in FIG. 2 and will now be described herein. It will be understood that it is not necessary for the mobile device 100a to have all the elements illustrated in FIG. 2. For example, the mobile device 100a may have any combination of the various elements illustrated in FIG. 2. Moreover, the mobile device 100a may have additional elements to those illustrated in FIG. 2.

The mobile device 100a includes one or more processors 110a, a non-transitory memory 120a operatively coupled to the one or more processors 110a, an I/O hub 130a, a network interface 140a, and a power source 150a.

The memory 120a comprises a set of instructions of computer-executable program code. The set of instructions are executable by the one or more processors 110a to cause the one or more processors 110a to execute an operating system (OS) 121a and one or more software applications of a software application module 122a that reside in the memory 120a. The one or more software applications residing in the memory 120a includes, but is not limited to, a financial institution application that is associated with the financial institution servers 200 (FIG. 1) and which facilitates user access to the one or more user accounts in addition to user management of the one or more user accounts. The financial institution application comprises a mobile financial institution application that facilitates establishment of a secure connection between the mobile device 100a and the one or more financial institution servers 200 (FIG. 1).

The memory 120a also includes one or more data stores 123a that are operable to store one or more types of data. The mobile device 100a may include one or more interfaces that facilitate one or more systems or modules thereof to transform, manage, retrieve, modify, add, or delete, the data residing in the data stores 123a. The one or more data stores 123a may comprise volatile and/or non-volatile memory. Examples of suitable data stores 123a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 123a may be a component of the one or more processors 110a, or alternatively, may be operatively connected to the one or more processors 110a for use thereby. As set forth, described, and/or illustrated herein, “operatively connected” may include direct or indirect connections, including connections without direct physical contact.

The memory 120a also includes an SMS (short messaging service) module 124a operable to facilitate user transmission and receipt of text messages via the mobile device 100a though the network 300 (FIG. 1). In one example embodiment, a user may receive text messages from the financial institution that are associated with the user access and the user management of the one or more user accounts. An email module 125a is operable to facilitate user transmission and receipt of email messages via the mobile device 100a through the network 300 (FIG. 1). In one example embodiment, a user may receive email messages from the financial institution that are associated with the user access and the user management of the one or more user accounts. A user may utilize a web browser module 126a that is operable to facilitate user access to one or more websites associated with the financial institution through the network 300 (FIG. 1).

In accordance with one or more embodiments, the mobile device 100a includes an I/O hub 130a operatively connected to other systems and subsystems of the mobile device 100a. The I/O hub 130a may include one or more of an input interface, an output interface, and a network controller to facilitate communications between the user device 100 and the server 200 (FIG. 1). The input interface and the output interface may be integrated as a single, unitary user interface 131a, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The mobile device 100a includes a network interface 140a operable to facilitate connection to the network 300. The mobile device 100a also includes a power source 150a that comprises a wired powered source, a wireless power source, a replaceable battery source, or a rechargeable battery source.

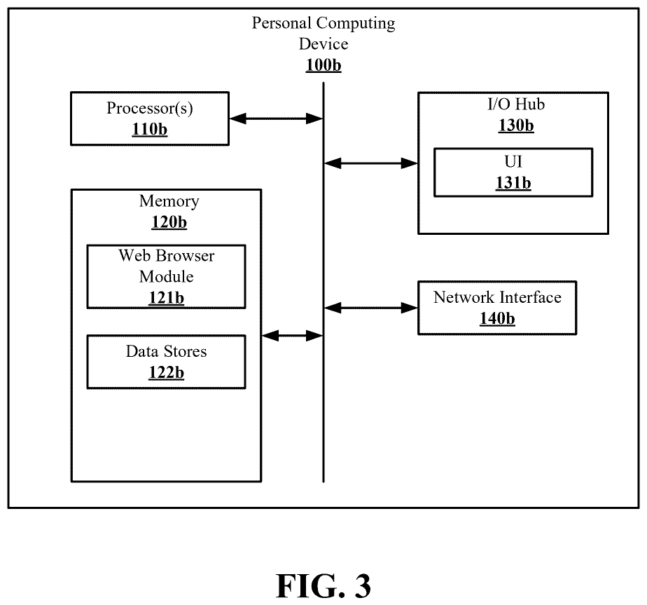

In the illustrated example embodiment of FIG. 3, the user device 100 (FIG. 1) comprises a personal computing device 100b. Some of the possible operational elements of the personal computing device 100b are illustrated in FIG. 3 and will now be described herein. It will be understood that it is not necessary for the personal computing device 100b to have all the elements illustrated in FIG. 3. For example, the personal computing device 100b may have any combination of the various elements illustrated in FIG. 3. Moreover, the personal computing device 100b may have additional elements to those illustrated in FIG. 3.

The personal computing device 100b includes one or more processors 110b, a non-transitory memory 120b operatively coupled to the one or more processors 110b, an I/O hub 130b, and a network interface 140b. The I/O hub 130b may include one or more of an input interface, an output interface, and a network controller to facilitate communications between the user device 100 and the server 200 (FIG. 2). The input interface and the output interface may be integrated as a single, unitary user interface 131b, or alternatively, be separate as independent interfaces that are operatively connected.

The memory 120b comprises a set of instructions of computer-executable program code. The set of instructions are executable by the one or more processors 110b to cause the one or more processors 110b to control the web browser module 121b in a manner that facilitates user access to a web browser having one or more websites associated with the financial institution through the network 300.

The memory 120b also includes one or more data stores 122b that are operable to store one or more types of data. The personal computing device 100b may include one or more interfaces that facilitate one or more systems or modules thereof to transform, manage, retrieve, modify, add, or delete, the data residing in the data stores 122b. The one or more data stores 122a may comprise volatile and/or non-volatile memory. Examples of suitable data stores 122b include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 122b may be a component of the one or more processors 110b, or alternatively, may be operatively connected to the one or more processors 110b for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 110a (FIG. 2), 110b may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110a (FIG. 2), 110b may comprise at least one hardware circuit (e.g., an integrated circuit) operable to carry out instructions contained in program code. In embodiments in which there is a plurality of processors, such processors may work independently from each other, or one or more processors may work in combination with each other.

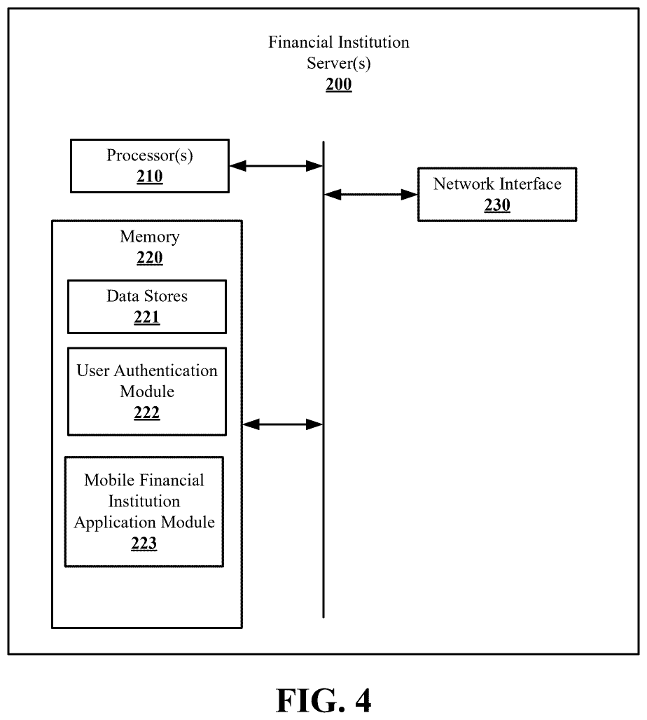

As illustrated in FIG. 4, the one or more financial institution servers 200 includes one or more processors 210, a non-transitory memory 220 operatively coupled to the one or more processors 210, and a network interface 230. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The memory 220 comprises a set of instructions of computer-executable program code. The set of instructions are executable by the one or more processors 210 in manner that facilitates control of a user authentication module 222 and a mobile financial institution application module 223 having one or more mobile financial institution applications that reside in the memory 220.

The memory 220 also includes one or more data stores 221 that are operable to store one or more types of data, including but not limited to, user account data and user authentication data. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The computer-executable program code may instruct the one or more processors 210 to cause the user authentication module 222 to authenticate a user in order to gain user access to the one or more user accounts. The user authentication module 222 may be caused to request user input user data or user identification that include, but are not limited to, user identity (e.g., user name), a user passcode, a cookie, user biometric data, a private key, a token, and/or another suitable authentication data or information.

The computer-executable program code of the one or more mobile financial institution applications of the mobile financial institution application module 223 may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 223 are operable to communicate with the user device 100 (FIG. 1) in a manner which facilitates user access to the one or more user accounts in addition to user management of the one or more user accounts based on successful user authentication.

In accordance with one or more embodiments set forth, described, and/or illustrated herein, the network 300 (FIG. 1) may comprise a wireless network, a wired network, or any suitable combination thereof. For example, the network 300 (FIG. 1) is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

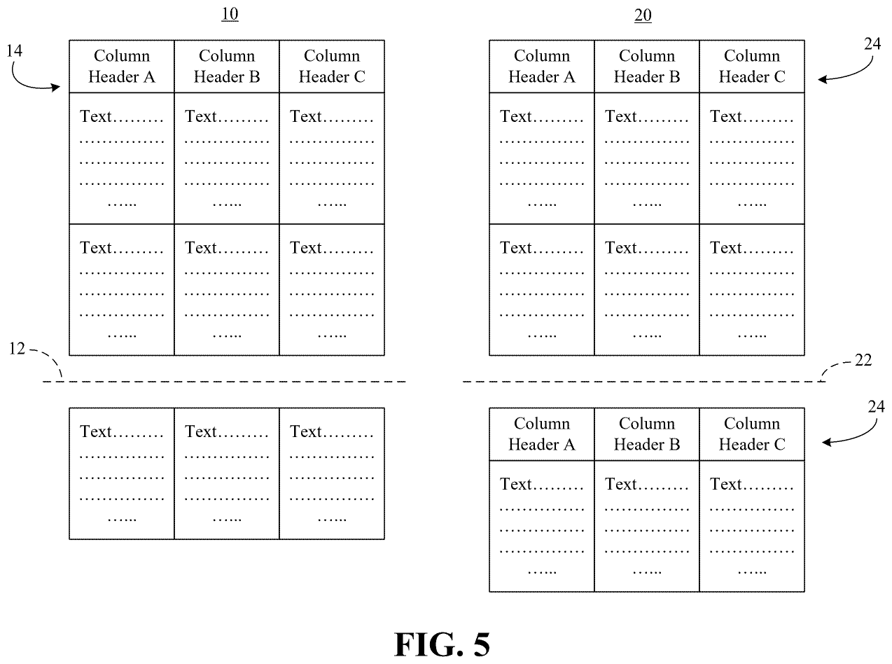

Turning now to FIG. 5, a conventional page layout 10 for a portable document format (PDF) file is shown in which the underlying dataset (e.g., document data, input data) includes a table. In the illustrated example, a page break 12 occurs in the middle of the table and column headers 14 are placed only on the first page of the table. The page break 12 could be associated with text being added to one or more rows of the table after the PDF file is initially generated. Such a result might be obtained from a conventional low-level PDF generation library and/or static PDF template. By contrast, the technology described herein produces an enhanced page layout 20 for a PDF file in which column headers 24 are automatically repeated at the top of the table after a page break 22 (e.g., resulting grom text being added to one or more rows of the table after the PDF file is initially generated). Accordingly, the enhanced page layout 20 renders the table more readable to the user. As will be discussed in greater detail, the technology described herein achieves the enhanced page layout 20 via reusable objects/components that can automatically vary the enhanced page layout 20. The reusable objects can also be used to control other attributes of the enhanced page layout 20 such as, for example, the location of the page break 22, page orientations (e.g., landscape, portrait), and so forth.

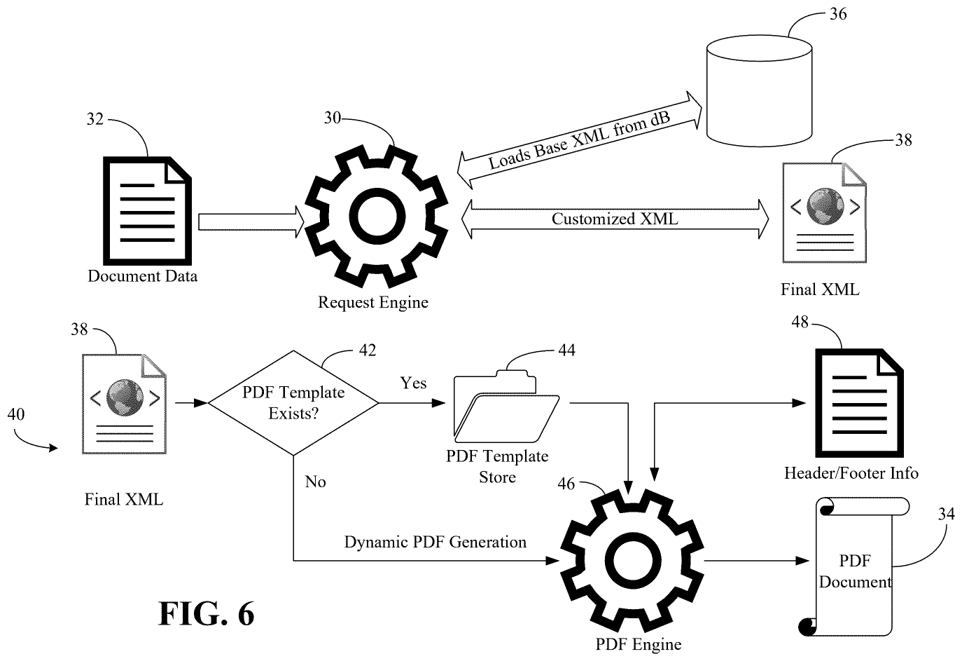

FIG. 6 shows a request engine 30 that receives, retrieves and/or detects document data 32 (e.g., input data, underlying dataset) associated with a request to generate a PDF document 34 (e.g., file). The request engine 30 loads a base XML file from a database 36 and generates a modified XML file 38 based on the document data 32 and the base XML file. The modified XML file 38 includes a set of reusable objects that can be used to build the PDF document 34 dynamically. For example, a grid object may display tabular data with column headers. If a page break occurs in the middle of the grid, the page break can be automatically detected to ensure that the column headers are repeated on the next page.

In an embodiment, each reusable object includes all the appropriate logic encapsulated inside the component and does not need to be re-written for each scenario. For example, if a grid is to be placed on a template, the technology described herein can simply add a 5-column grid or a 3-column grid, without being concerned about the column sizing logic (e.g., the grid object is pre-configured to handle the column sizing). Examples of other reusable objects include, for example, a barcode component that displays a barcode with variable data and size, a signature component that generates a set of signature and date lines with variable number, a layout component that controls the display of child components with variable layout patterns, and so forth. For example, the layout object might display two components one on top of the other or display the two components side-by-side.

The modified XML file 38 is input to a PDF pipeline 40, which determines at processing block 42 whether a PDF template exists for the modified XML file 38. If so, the PDF template is retrieved from a template store 44 and a PDF print engine 46 dynamically generates the PDF document 34 based on the PDF template and the modified XML file 38. Otherwise, the template retrieval from the template store 44 is bypassed and the PDF print engine 46 dynamically generates the PDF document 34 based on the modified XML file 38 (e.g., and no PDF template). In either instance, one or more attributes associated with the page layout of the PDF document 34 are variable in accordance with the set of reusable objects. For example, the attribute(s) can include page break locations, page orientations, column header settings, and so forth. The illustrated PDF print engine 46 also generates page header and/or footer information 48 based on the modified XML file 38, wherein the page header and/or footer information 48 is also variable in accordance with the reusable objects. As will be discussed in greater detail, if the document data 32 changes over time (e.g., as the result of a row insertion operation, a template merge operation, a font size adjustment, etc.), the modified XML file 38 and the PDF document 34 can be regenerated to obtain a page layout that is most suitable for the new dataset. The request engine 30 and the PDF print engine 46 may be implemented in logic instructions, configurable hardware, fixed-functionality hardware, etc., or any combination thereof. In an example, the PDF print engine is implemented via an ITEXT PDF library.

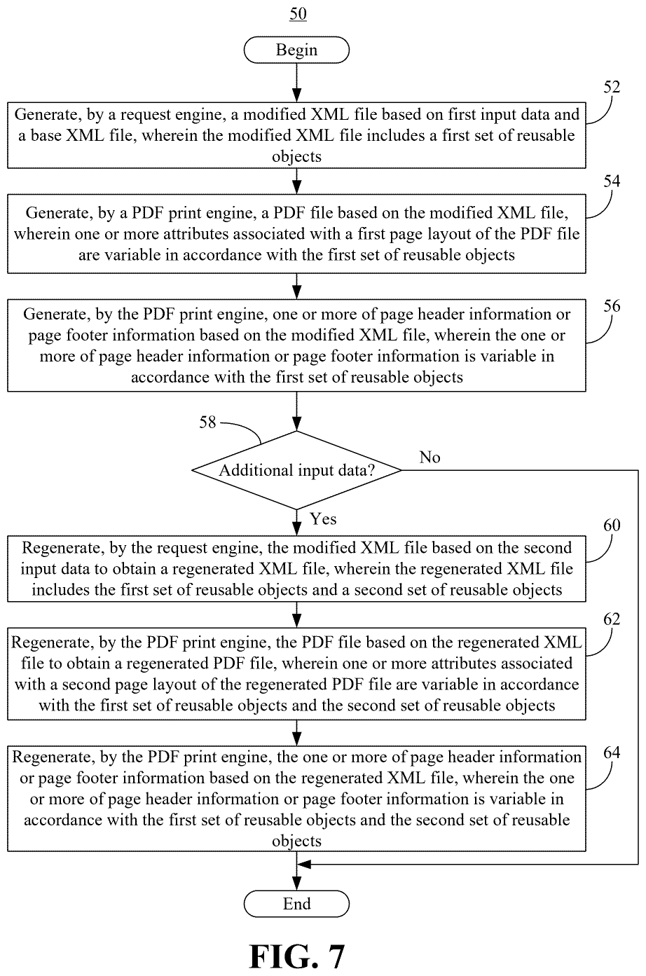

FIG. 7 shows a computer-implemented method 50 of operating a performance-enhanced computing system. The computer-implemented method 50 may generally be implemented in a server such as, for example, the financial institution server(s) 200 (FIGS. 1 and 4), already discussed. More particularly, the computer-implemented method 50 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the computer-implemented method 50 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 52 provides for generating, by a request engine, a modified XML file based on first input data (e.g., document data, underlying dataset) and a base XML file, wherein the modified XML file includes a first set of reusable objects (e.g., including a grid object that holds data in memory). In an embodiment, block 52 defines an XML tag and associated parameters that can be modified for each object. For example, the Grid tag might be defined as:
<Grid RepeatHeader=“true”
   <GridColumn Name=“Name” Width=“20” />
   <GridColumn Name=“Address” Width=“40” />
</Grid>

Block 54 generates, by a PDF print engine, a PDF file based on the modified XML file, wherein one or more attributes associated with a first page layout of the PDF file are variable in accordance with the first set of reusable objects. Thus, the PDF engine can read the modified XML file and generate the PDF output based on the tags and parameters in the modified XML file. The attribute(s) associated with the first page layout can include, for example, page break locations, page orientations (e.g., landscape, portrait), column header settings (e.g., repeat after page break), and so forth. In one example, block 54 generates the PDF file further based on a PDF template. Block 56 may generate, by the PDF print engine, one or more of page header information or page footer information based on the modified XML file. In the illustrated example, the page header information (e.g., form number) and/or page footer information is also variable in accordance with the first set of reusable objects. For example, if the input data includes information for a barcode, block 56 might place the barcode within the footer of the PDF file (e.g., enabling the PDF file to be scanned for form processing).

Block 58 detects whether additional input data (e.g., second input data) is available. The second input data may be associated with a row insertion operation (e.g., increasing the size of a table), a template merge operation (e.g., combining two PDF forms), a font size adjustment (e.g., increasing or decreasing the font size of the text in the PDF file), and so forth. If the second input data is detected at block 58, block 60 regenerates the modified XML file based on the second input data to obtain a regenerated XML file, wherein the regenerated XML file includes the first set of reusable objects and a second set of reusable objects. For example, the second set of reusable objects can be directed to changes associated with the second input data (e.g., text added to a table, causing the table to span multiple pages). Block 62 regenerates, by the PDF print engine, the PDF file based on the regenerated XML file to obtain a regenerated PDF file. In the illustrated example, one or more attributes associated with a second page layout of the regenerated PDF file are variable in accordance with the first set of reusable objects and the second set of reusable objects.

Additionally, block 64 may regenerate, by the PDF print engine, page header information and/or page footer information based on the regenerated XML file, wherein the page header information and/or page footer information is variable in accordance with the first set of reusable objects and the second set of reusable objects. The regenerated PDF file, the header information and/or the footer information may also be generated based on a PDF template. Blocks 58, 60, 62 and 64 may be repeated as appropriate to maintain the optimal page layout for the PDF file over time (e.g., as changes to the document data are made). The method 50 therefore enhances performance at least to the extent that the reusable objects/components are high-level building blocks that produce more user-friendly PDF files. Moreover, if the dataset changes over time, the reusable objects enable the PDF print engine to intelligently deviate from the original page layout.

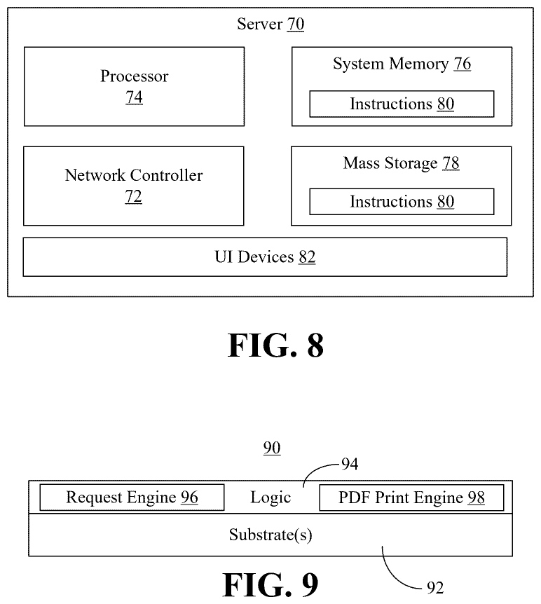

FIG. 8 shows a server 70 (e.g., computing system) that includes a network controller 72 (e.g., wired, wireless), a processor 74 (e.g., host processor, central processing unit/CPU), a volatile memory 76 (e.g., system memory, DRAM), and mass storage 78 (e.g., storage device, flash memory, optical disc, hard disk drive/HDD, solid state drive/SDD). In the illustrated example, the processor 74 executes instructions 80 retrieved from the volatile memory 76 and/or the mass storage 78 to conduct one or more aspects of the computer-implemented method 50 (FIG. 7), already discussed. Thus, execution of the instructions 80 causes the processor 74 to generate a modified XML file based on first input data and a base XML file, wherein the modified XML file includes a first set of reusable objects. Execution of the instructions 80 also causes the processor 74 to generate a PDF file based on the modified XML file, wherein one or more attributes (e.g., page break locations, page orientations, column header settings, etc.) associated with a first page layout of the PDF file are variable in accordance with the first set of reusable objects. In an embodiment, the PDF file is output via one or more UI devices 82 and/or the network controller 72.

The server 70 is therefore considered performance-enhanced at least to the extent that the reusable objects/components are high-level building blocks that produce more user-friendly PDF files. Moreover, if the dataset changes over time, the reusable objects enable the PDF print engine to intelligently deviate from the original page layout.

FIG. 9 shows a semiconductor apparatus 90 (e.g., chip, die, package). The illustrated apparatus 90 includes one or more substrates 92 (e.g., silicon, sapphire, gallium arsenide) and logic 94 (e.g., transistor array and other integrated circuit/IC components) coupled to the substrate(s) 92. In an embodiment, the logic 94 implements one or more aspects of the method 50 (FIG. 7), already discussed.

Thus, the logic 94 can generate, by a request engine 96, a modified XML file based on first input data and a base XML file, wherein the modified XML file includes a first set of reusable objects (e.g., including a grid object). The logic 94 can also generate, by a PDF print engine 98, a PDF file based on the modified XML file, wherein one or more attributes associated with a first page layout of the PDF file are variable in accordance with the first set of reusable objects.

The logic 94 may be implemented at least partly in configurable or fixed-functionality hardware. In one example, the logic 94 includes transistor channel regions that are positioned (e.g., embedded) within the substrate(s) 92. Thus, the interface between the logic 94 and the substrate(s) 92 may not be an abrupt junction. The logic 94 may also be considered to include an epitaxial layer that is grown on an initial wafer of the substrate(s) 92.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C”may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A computing system, comprising:
a network controller;
a processor coupled to the network controller; and
a memory coupled to the processor, the memory including a plurality of instructions, which when executed by the processor, cause the processor to:
generate a modified extensible markup language (XML) file based on first input data and a base XML file, wherein the modified XML file includes a first set of reusable objects, and
generate a portable document format (PDF) file based on the modified XML file, wherein one or more attributes associated with a first page layout of the PDF file are variable in accordance with the first set of reusable objects.

2. The computing system of claim 1, wherein the plurality of instructions, when executed, further cause the processor to:
detect second input data,
regenerate the modified XML file based on the second input data to obtain a regenerated XML file, wherein the regenerated XML file further includes the first set of reusable objects and a second set of reusable objects, and
regenerate the PDF file based on the regenerated XML file to obtain a regenerated PDF file, wherein one or more attributes associated with a second page layout of the regenerated PDF file are variable in accordance with the first set of reusable objects and the second set of reusable objects.

3. The computing system of claim 2, wherein the second input data is to be associated with one or more of a row insertion operation, a template merge operation or a font size adjustment.

4. The computing system of claim 1, wherein the plurality of instructions, when executed, further cause the processor to generate one or more of page header information or page footer information based on the modified XML file, and wherein the one or more of page header information or page footer information is variable in accordance with the first set of reusable objects.

5. The computing system of claim 4, wherein the PDF file and the one or more of page header information or page footer information are generated further based on a PDF template.

6. The computing system of claim 1, wherein the one or more attributes associated with the first page layout include one or more of page break locations, page orientations or column header settings.

7. At least one computer readable storage medium comprising a plurality of instructions, which when executed by a computing system, cause the computing system to:
generate a modified extensible markup language (XML) file based on first input data and a base XML file, wherein the modified XML file includes a first set of reusable objects; and
generate a portable document format (PDF) file based on the modified XML file, wherein one or more attributes associated with a first page layout of the PDF file are variable in accordance with the first set of reusable objects.

8. The at least one computer readable storage medium of claim 7, wherein the plurality of instructions, when executed, further cause the computing system to:
detect second input data;
regenerate the modified XML file based on the second input data to obtain a regenerated XML file, wherein the regenerated XML file further includes the first set of reusable objects and a second set of reusable objects; and
regenerate the PDF file based on the regenerated XML file to obtain a regenerated PDF file, wherein one or more attributes associated with a second page layout of the regenerated PDF file are variable in accordance with the first set of reusable objects and the second set of reusable objects.

9. The at least one computer readable storage medium of claim 8, wherein the second input data is to be associated with a row insertion operation.

10. The at least one computer readable storage medium of claim 8, wherein the second input data is to be associated with a template merge operation.

11. The at least one computer readable storage medium of claim 8, wherein the second input data is to be associated with a font size adjustment.

12. The at least one computer readable storage medium of claim 7, wherein the plurality of instructions, when executed, further cause the computing system to generate one or more of page header information or page footer information based on the modified XML file, wherein the one or more of page header information or page footer information is variable in accordance with the first set of reusable objects, and wherein the PDF file and the one or more of page header information or page footer information are generated further based on a PDF template.

13. The at least one computer readable storage medium of claim 7, wherein the one or more attributes associated with the first page layout include one or more of page break locations, page orientations or column header settings.

14. A method, comprising:
generating, by a request engine, a modified extensible markup language (XML) file based on first input data and a base XML file, wherein the modified XML file includes a first set of reusable objects; and
generating, by a portable document format (PDF) print engine, a PDF file based on the modified XML file, wherein one or more attributes associated with a first page layout of the PDF file are variable in accordance with the first set of reusable objects.

15. The method of claim 14, further comprising:
detecting second input data;
regenerating, by the request engine, the modified XML file based on the second input data to obtain a regenerated XML file, wherein the regenerated XML file further includes the first set of reusable objects and a second set of reusable objects; and
regenerating, by the PDF print engine, the PDF file based on the regenerated XML file to obtain a regenerated PDF file, wherein one or more attributes associated with a second page layout of the regenerated PDF file are variable in accordance with the first set of reusable objects and the second set of reusable objects.

16. The method of claim 15, wherein the second input data is associated with a row insertion operation.

17. The method of claim 15, wherein the second input data is associated with a template merge operation.

18. The method of claim 15, wherein the second input data is associated with a font size adjustment.

19. The method of claim 14, further including generating, by the PDF print engine, one or more of page header information or page footer information based on the modified XML file, wherein the one or more of page header information or page footer information is variable in accordance with the first set of reusable objects, and wherein the PDF file and the one or more of page header information or page footer information are generated further based on a PDF template.

20. The method of claim 14, wherein the one or more attributes associated with the first page layout include one or more of page break locations, page orientations or column header settings, wherein the request engine and the PDF print engine include logic coupled to one or more substrates, and wherein the logic is implemented at least partly on one or more of configurable or fixed-functionality hardware.
